(19) United States
(12) Patent Application Publication
(10) Pub. No.: US 2025/0164974 A1
(43) Pub. Date: May 22, 2025

(54) Production Management Device, Production Management System, and Production Management Method

(71) Applicant: Hitachi, Ltd., Chiyoda-ku, Tokyo (JP)

(72) Inventors: Takahiro NAKANO, Tokyo (JP); Daiki KAJITA, Tokyo (JP)

(21) Appl. No.: 18/730,374

(22) PCT Filed: Sep. 2, 2022
(86) PCT No.: PCT/JP2022/033064

§ 371 Date: Jul. 19, 2024

(30) Foreign Application Priority Data
Feb. 14, 2022 (JP) 2022-020784

(51) Int. Cl. G05B 19/418; G06Q 10/0639

(52) U.S. Cl. CPC G05B 19/4184; G06Q 10/06393

(57) ABSTRACT

The present invention can draft a plurality of countermeasures that can be quantitatively evaluated from a viewpoint corresponding to a plurality of evaluation indexes.

The present invention includes: a countermeasure planning section that formulates a countermeasure plan for production resources of factory equipment in which an abnormality is detected; a storage section that stores line capacity information and plan information, the line capacity information being associated with the countermeasure plan and the production resources and including registered parameters indicating the production capacity of a production line before and after countermeasure implementation, the plan information indicating the production capacity of the production line that involves the production resources in a normal state; and a capacity model creation section that creates a capacity model predicting the production capacity of the production line before and after countermeasure implementation based on the countermeasure plan through the use of the formulated countermeasure plan, the line capacity information, and the plan information.

### TECHNICAL FIELD

The present invention relates to a production management device, a production management system, and a production management method. The present invention claims priority benefit of Japanese Patent Application No. 2022-020784 filed on Feb. 14, 2022, and for designated countries where incorporating by reference to documents is permitted, the contents described in the application of the above-mentioned patent are incorporated into the present application by reference.

### BACKGROUND ART

Patent Literature 1 relates to a monitoring device for industrial equipment, and states that the monitoring device includes a maintenance fault diagnosis section for detecting a maintenance fault event of an air compressor based on sensor data, a fault risk estimation section for estimating a fault mode that occurs over time when the maintenance fault event is left unattended, and a maintenance effect estimation section for estimating and displaying the time and cost of recovery for restoring normality and calculating and displaying the probability of fault occurrence of fault mode in a case where, in response to the maintenance fault event, maintenance measures are taken and in a case where they are not taken, and that the monitoring device makes it possible to detect a fault in the maintenance of industrial equipment, notify to urge a user to perform maintenance, and notify the user of benefits such as maintenance cost reduction by maintenance.

### CITATION LIST

### Patent Literature

Patent Literature 1: International Publication No. WO 2018/147362

### SUMMARY OF INVENTION

### Technical Problem

Normally, when a fault or other malfunction (equipment fault) occurs in factory equipment, production engineers of a factory analyze the operating status of various equipment in a production line, and plan countermeasures. However, the current situation is that deciding what kind of countermeasures to implement relies on the experience and intuition of the production engineers. Therefore, there is a problem in that it takes many man-hours and a long time to plan the countermeasures. Furthermore, it is desirable that the planned countermeasures be quantitatively evaluable from the perspective of multiple evaluation indicators.

It should be noted that Patent Literature 1 discloses a technology for issuing a notification to prompt for maintenance, estimating the risk of leaving a maintenance fault unattended, and conveying information regarding, for example, the time and cost of recovery. However, the technology disclosed in Patent Literature 1 does not take into account the planning of multiple countermeasures that can be quantitatively evaluated from the perspective of multiple evaluation indicators.

The present invention has been made in view of the above problems. An object of the present invention is to plan multiple countermeasures that can be quantitatively evaluated from the perspective of multiple evaluation indicators.

### Solution to Problem

The present application includes multiple means for solving at least some of the above problems, and examples thereof are described below. In order to solve the above problem, according to an aspect of the present invention, there is provided a production management device including a countermeasure planning section, a storage section, and a capacity model creation section. The countermeasure planning section formulates a countermeasure plan for production resources of factory equipment in which an abnormality is detected. The storage section stores line capacity information and plan information. The line capacity information is associated with the countermeasure plan and the production resources, and includes registered parameters indicating the production capacity of a production line before and after countermeasure implementation. The plan information indicates the production capacity of the production line that includes the production resources in a normal state. The capacity model creation section creates a capacity model predicting the production capacity of the production line before and after countermeasure implementation based on the countermeasure plan through the use of the formulated countermeasure plan, the line capacity information, and the plan information.

### Advantageous Effects of Invention

The present invention makes it possible to formulate multiple countermeasures that can be quantitatively evaluated from the perspective of multiple evaluation indicators.

### BRIEF DESCRIPTION OF DRAWINGS

FIG. 1 is a diagram illustrating an example of the outline configuration of a production management system.

FIG. 2 is a diagram illustrating an example of processing plan information.

FIG. 3 is a diagram illustrating an example of work plan information.

FIG. 4 is information illustrating an example of production plan information.

FIG. 5 is a flowchart illustrating an example of a production management process.

FIG. 6 is a flowchart illustrating an example of a coordination planning process.

FIG. 7 is a diagram illustrating an example of a production line capacity model.

FIG. 8 is a diagram illustrating an example of a countermeasure confirmation screen.

FIG. 9 is a diagram illustrating another example of the countermeasure confirmation screen.

FIG. 10 is a diagram illustrating an example of the hardware configuration of a production management device.

### DESCRIPTION OF EMBODIMENTS

An embodiment of the present invention will now be described with reference to the accompanying drawings.

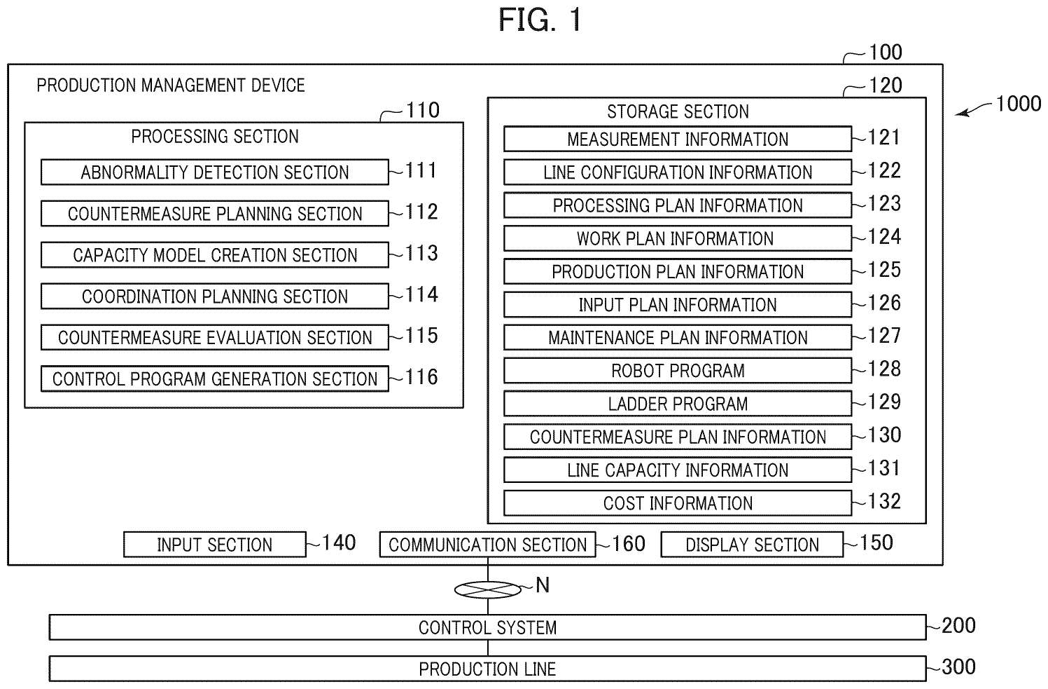

FIG. 1 is a diagram illustrating an example of the outline configuration of a production management system 1000 according to the present embodiment. As illustrated in FIG. 1, the production management system 1000 includes a production management device 100, a control system 200, and a production line 300. Further, the production management device 100 and the control system 200 are connected so as to be able to communicate with each other through a network N, such as the Internet or other public network, a LAN (Local Area Network), or a WAN (Wide Area Network). Furthermore, the control system 200 and the production line 300 are connected to be able to communicate with each other, for example, through an in-factory network (e.g., a LAN).

The production management device 100 is a device that performs various processes related to product production management. For example, the production management device 100 creates various plans (e.g., production plans, processing plans, work plans, and periodic maintenance plans) used for manufacturing products, and stores such created plans.

Further, the production management device 100 outputs (transmits) instructions based on various plans, such as production plans, to the control system 200, which monitors and controls factory equipment (e.g., assembly robots and conveyors; hereinafter sometimes referred to the production resources). Furthermore, the production management device 100 acquires measurement information, which is outputted from the production resources through the control system 200, and creates a production plan change proposal or an unscheduled maintenance plan in accordance with the contents of the measurement information.

As illustrated, the above-described production management device 100 includes a processing section 110, a storage section 120, an input section 140, a display section 150, and a communication section 160.

The processing section 110 is a functional section that performs various processes, which are executed by the production management device 100. Specifically, the processing section 110 includes an abnormality detection section 111, a countermeasure planning section 112, a capacity model creation section 113, a coordination planning section 114, a countermeasure evaluation section 115, and a control program generation section 116.

The abnormality detection section 111 is a functional section that detects production resource abnormalities. Specifically, the abnormality detection section 111 detects production resource abnormalities by using the measurement information acquired through the control system 200. More specifically, when the measurement information includes an abnormal value, the abnormality detection section 111 detects an abnormality in a production resource that is the output source of the abnormal value.

The countermeasure planning section 112 is a functional section that formulates countermeasures to deal with production resource abnormalities. Specifically, the countermeasure planning section 112 formulates the countermeasures by deriving, from countermeasure plan information 130, a countermeasure plan indicating the association between the abnormal value detected by the abnormality detection section 111 and the production resource that has outputted the abnormal value.

The capacity model creation section 113 is a functional section that creates model information indicating the production capacity of the production line 300 (hereinafter sometimes referred to as the production line capacity model). Specifically, for the production line 300 including the production resource found to be abnormal, the capacity model creation section 113 creates the production line capacity model predicting the production capacity in each phase of unscheduled maintenance associated with the countermeasure plan, namely, each of the phases of before, during, and after countermeasure implementation. It should be noted that a process of creating the production line capacity model will be described in detail later.

The coordination planning section 114 is a functional section that formulates an unscheduled maintenance plan and a production plan change proposal in coordination with each other. It should be noted that a process of coordinated formulation of the above-mentioned unscheduled maintenance plan and production plan change proposal will be described in detail later.

The countermeasure evaluation section 115 is a functional section that generates information including a predetermined production KPI (Key Performance Indicator) for use in quantitative evaluation of countermeasures against detected abnormalities. Specifically, the countermeasure evaluation section 115 generates screen information for quantitative evaluation of countermeasures including the production KPI through the display section 150, and outputs the generated screen information to a presentation device such as a display.

The control program generation section 116 is a functional section that generates control programs for controlling the production resources of the production line 300. Specifically, the control program generation section 116 generates a robot program for controlling the operations of production resources and a ladder program for synchronizing the operations of devices in accordance, for example, with production plan information or with a production plan information change proposal. Further, the control program generation section 116 transmits the generated control programs to the control system 200 through the communication section 160.

The storage section 120 of the production management device 100 will now be described. The storage section 120 is a functional section for storing various information that is used in various processes executed by the processing section 110. Specifically, the storage section 120 stores measurement information 121, line configuration information 122, processing plan information 123, work plan information 124, production plan information 125, input plan information 126, maintenance plan information 127, a robot program 128, a ladder program 129, the countermeasure plan information 130, line capacity information 131, and cost information 132. It should be noted that the storage section 120 also stores information (e.g., the later-described countermeasure plan, unscheduled maintenance plan, production plan change proposal, and production KPI) generated by the processes executed by the processing section 110.

The measurement information 121 is log information indicating an operating status that is periodically outputted (e.g., every second or every minute) from the production resources. Specifically, the measurement information 121 is acquired by the communication section 160 through the control system 200 and then stored in the storage section 120. Further, the measurement information 121 includes normal values, which are outputted when there are no abnormalities in the production resources, or abnormal values, which are outputted when a fault or other malfunction occurs, and identification information (e.g., production resource ID) regarding the production resources associated with the outputted values.

The line configuration information 122 is information indicating the configuration of the production line 300. Specifically, the line configuration information 122 includes, for example, the identification information regarding the production resources involved in the production line 300 and information that identifies each production line 300 (e.g., production line ID).

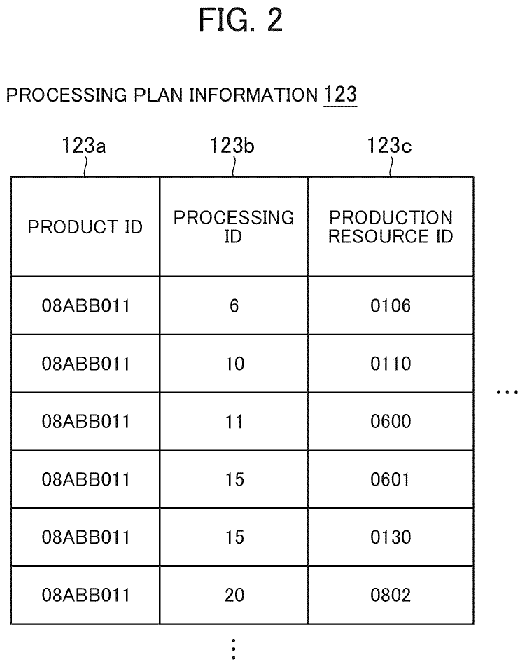

FIG. 2 is a diagram illustrating an example of the processing plan information 123. Information regarding the manufacturing process of a product is registered in the processing plan information 123. Specifically, a product ID 12a of a processing plan is information for identifying the product to be manufactured. A processing ID 123b is information for identifying each processing. A production resource ID 123c is information for identifying a production resource used in each processing.

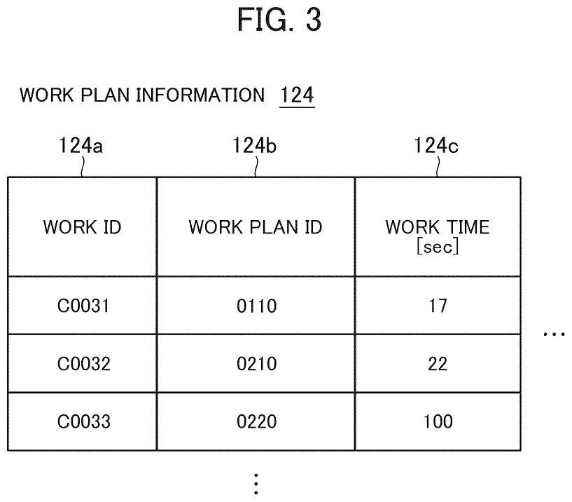

FIG. 3 is a diagram illustrating an example of the work plan information 124. Information indicating the contents of work performed in each manufacturing processing is registered in the work plan information 124. Specifically, a work ID 124a of the work plan information 124 is information that identifies a work, and is linked to the processing ID 123b of the processing plan. A work plan ID 124b is information that identifies a work plan and is used to register an ID indicating the contents of the work plan (e.g., assembly work). A work time 124c is information indicating the work time that is required when a production resource allocated to the processing specified by the work ID 124a executes the work specified by the work plan ID 124b. As described above, the work plan information 124 in which the work time required for each processing is registered also serves as information indicating the production capacity of the production line 300 in which the specified work is performed.

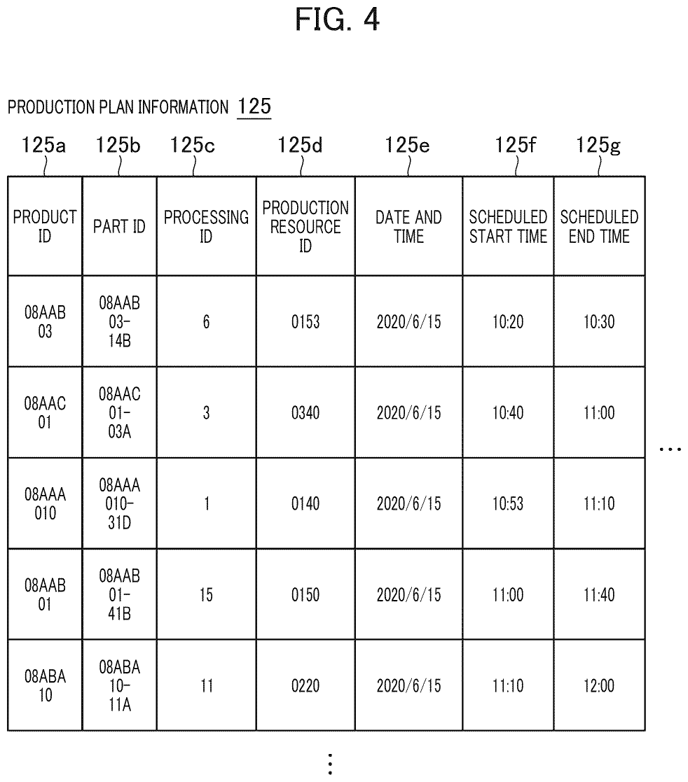

FIG. 4 is information illustrating an example of the production plan information 125. Information regarding a production plan for a product is registered in the production plan information 125. Specifically, a product ID 125a of the production plan is information for identifying the product to be manufactured. A part ID 125b is information for identifying the parts of the product. A processing ID 125c is information for identifying a processing. A production resource ID 125d is information for identifying the production resources. A date and time 125e is information indicating the date and time of execution of a predetermined processing, such as assembling a part identified by the associated part ID 125b, in the manufacture of the product identified by the associated product ID 125a. A scheduled start time 125f is information indicating the scheduled start time of the processing identified by the associated processing ID 125c. A scheduled end time 125g is information indicating the scheduled end time of such a processing.

The description below is given by returning to FIG. 1. The input plan information 126 is information indicating a target product production volume (the number of units to be manufactured) of a product over a predetermined period. Specifically, the input plan information 126 is used to register, for example, a monthly target product production volume that is calculated from the number of orders received and the predicted number of orders to be received for each product.

The maintenance plan information 127 is used to register plans for performing maintenance work, such as parts replacement and equipment adjustment. Specifically, the maintenance plan information 127 is used to register predetermined information, such as a work date and time, the type of maintenance work, the number of workers, and a work time. It should be noted that the maintenance plan information 127 is periodic maintenance plan information. The unscheduled maintenance plan, which is devised upon the occurrence, for example, of a fault, will be described later.

The robot program 128 is a program for operating a robot that is a production resource. Specifically, the robot program 128 is a program that defines the operation of the robot to perform, for example, the work identified by the work plan ID 124b indicated in the work plan information 124.

The ladder program 129 is a program for synchronizing the operations of the production resources in the production line 300, such as robots and conveyors.

The countermeasure plan information 130 is used to register countermeasure plans for abnormalities in the production resources. Specifically, the countermeasure plan information 130 is used to register multiple countermeasure plans (e.g., parts replacement, equipment adjustment, and equipment replacement) that are associated, for example, with production resource identification information and abnormal values. Further, the registered multiple countermeasure plans are basically associated with each abnormal value, and each countermeasure plan is associated with predetermined information, such as the number of workers and work time required for the associated unscheduled maintenance work.

The line capacity information 131 is used to register parameters indicating the production capacity of the production line 300. Specifically, the line capacity information 131 is used to register the parameters indicating the production capacity of the production line 300 in each of the phases of before, during, and after implementation of countermeasures that are associated with individual combinations of countermeasure plan, production line 300, and production resources.

The cost information 132 is used to register various types of costs. Specifically, the cost information 132 is used to register, for example, the costs (e.g., equipment costs such as parts replacement) of maintenance work (including unscheduled maintenance work) associated with individual combinations of countermeasure plan, production line 300, and production resources, the costs per unit time for workers performing maintenance work, the overtime costs for workers, and the penalty costs resulting from delayed delivery of individual products.

The input section 140 of the production management device 100 will now be described. The input section 140 is a functional section that receives instructions and information input from a user (operator) through an input device included in the production management device 100. Further, the input section 140 receives information input from the control system 200 through the communication section 160 and from the production line 300 through the control system 200.

The display section 150 is a functional section that generates display information and displays the generated display information on a presentation device (display) included in the production management device 100 or in an undepicted external device. Specifically, the display section 150 generates, for example, screen information, including the production KPI, in accordance with instructions from the countermeasure evaluation section 115, and outputs the generated screen information to the presentation device.

The communication section 160 is a functional section that performs information communication with an external device (the control system 200 in the present example). Specifically, the communication section 160 acquires the measurement information 121 from the production resources in the production line 300 through the control system 200. Further, the communication section 160 transmits product manufacturing instructions and control programs based on the production plan (including the production plan change proposal) to the control system 200.

The functional sections of the production management device 100 have been described above.

It should be noted that the control system 200 is a system for monitoring and managing, for example, the production line 300 of a factory and the production resources provided as factory equipment. Upon acquiring the manufacturing instructions and production resource control programs (e.g., the robot program 128 or the ladder program 129) from the production management device 100, the control system 200 uses the acquired instructions and programs to output a control signal to each production resource in the production line 300.

The production line 300, which is a group of equipment for each cell, includes various types of production resources for product manufacturing in a factory. The various types of production resources involved in the production line 300 operate in accordance with the robot program 128 and ladder program 129 obtained from the control system 200.

An example of the outline configuration of the production management system 1000 according to the present embodiment has been described above.

### Description of Operation

The processes performed by the production management device 100 will now be described in detail.

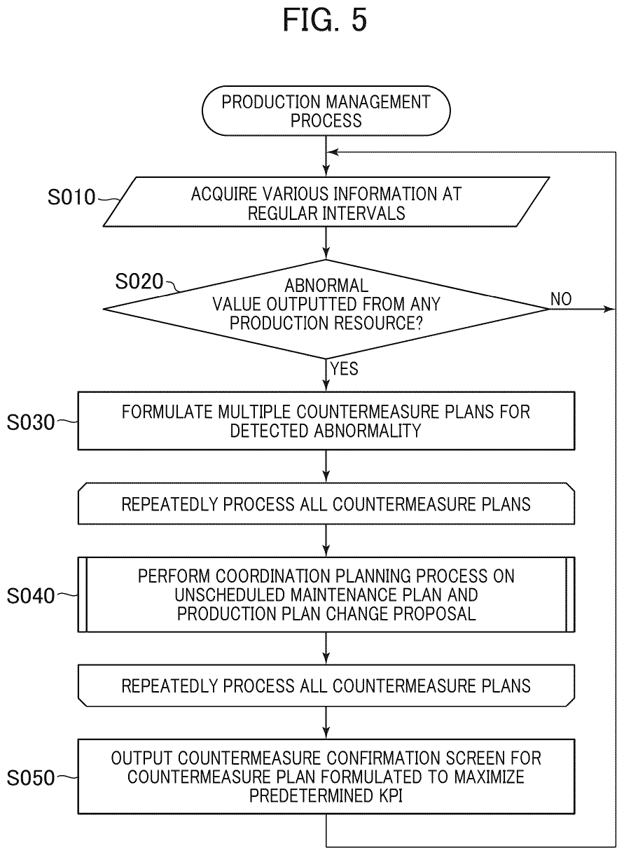

FIG. 5 is a flowchart illustrating an example of a production management process that is performed by the production management device 100. The production management process may start, for example, when the production management device 100 starts up, or when a process execution instruction is received from the user through the input section 140.

When the production management process starts, the abnormality detection section 111 acquires various information at regular intervals (e.g., at intervals of several minutes to several hours) (step S010). Specifically, the abnormality detection section 111 acquires, from the storage section 120, the latest measurement information 121 supplied from the control system 200 through the communication section 160, the line configuration information 122, the processing plan information 123, the work plan information 124, the production plan information 125, the input plan information 126, the robot program 128, the ladder program 129, the countermeasure plan information 130, the line capacity information 131, and the cost information 132.

Next, the abnormality detection section 111 uses the latest measurement information 121 to determine whether an abnormal value is outputted from a production resource (step S020). Specifically, when the measurement information 121 includes an abnormal value outputted from a production resource, the abnormality detection section 111 determines that the abnormal value is outputted from the production resource.

If it is determined that no production resource has outputted an abnormal value (“NO” in step S020), the abnormality detection section 111 returns the process to step S010. Meanwhile, if it is determined that an abnormal value is outputted from a production resource (“YES” in step S020), the abnormality detection section 111 moves the process to step S030. In this instance, the abnormality detection section 111 references the measurement information 121 to identify the abnormal value and the identification information regarding the production resource that has outputted the abnormal value.

Next, the countermeasure planning section 112 formulates multiple countermeasure plans for the detected abnormality (step S030). Specifically, the countermeasure planning section 112 formulates the multiple countermeasure plans by deriving, from the countermeasure plan information 130, the abnormal value and multiple countermeasures associated with the identification information regarding the production resource that has outputted the abnormal value.

Next, for each formulated countermeasure plan, the coordination planning section 114 performs a coordination planning process on the unscheduled maintenance plan and the production plan change proposal (step S040).

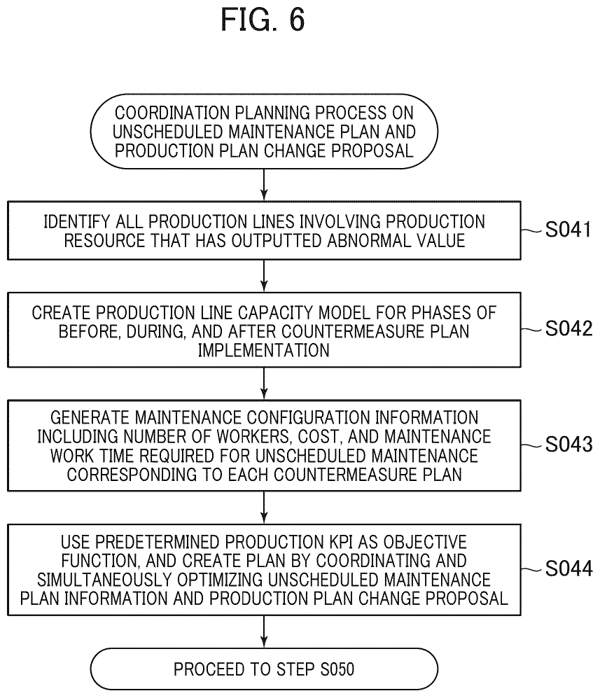

FIG. 6 is a flowchart illustrating an example of the coordination planning process performed on the unscheduled maintenance plan and the production plan change proposal.

In step S041, the capacity model creation section 113 identifies all production lines 300 related to the production resource that has outputted the abnormal value. Specifically, the capacity model creation section 113 references, for example, the production plan information 125 to identify a product ID associated with the identification information regarding the production resource that has outputted the abnormal value, acquires, from the line configuration information 122, the identification information regarding a production line 300 for manufacturing a product with the identified product ID, and thus identifies the production line 300.

It should be noted that, when the production resource that has outputted the abnormal value is involved in the manufacturing work for multiple products, that is, when such a production resource is involved in multiple production lines 300, the capacity model creation section 113 identifies all of the multiple production lines 300.

Next, the capacity model creation section 113 creates the production line capacity model for each of the phases of before, during, and after countermeasure plan implementation (step S042). Specifically, the capacity model creation section 113 derives, from the line capacity information 131, the parameters indicating the production capacity of a production line 300 before, during, and after countermeasure implementation, which varies from one phase to another depending on a production resource targeted for countermeasure implementation (unscheduled maintenance) and on the countermeasure plan (the type of countermeasure). More specifically, the capacity model creation section 113 derives, from the line capacity information 131, the parameters indicating the production capacity of each phase in accordance with the formulated countermeasure plan, the identified production line 300, and the identification information regarding the production resource that has outputted the abnormal value.

Further, the capacity model creation section 113 creates the production line capacity model for each phase by using the work plan information 124 and the derived parameters. Specifically, the capacity model creation section 113 calculates the work time for each task in each of the phases of before, during, and after countermeasure implementation by multiplying the work time 124c indicated in the work plan information 124 regarding the associated production line 300 by the phase-specific parameters. Furthermore, the capacity model creation section 113 creates the production line capacity model for each phase that includes the calculated work time and the work ID 124a and work plan ID 124b associated with each work time.

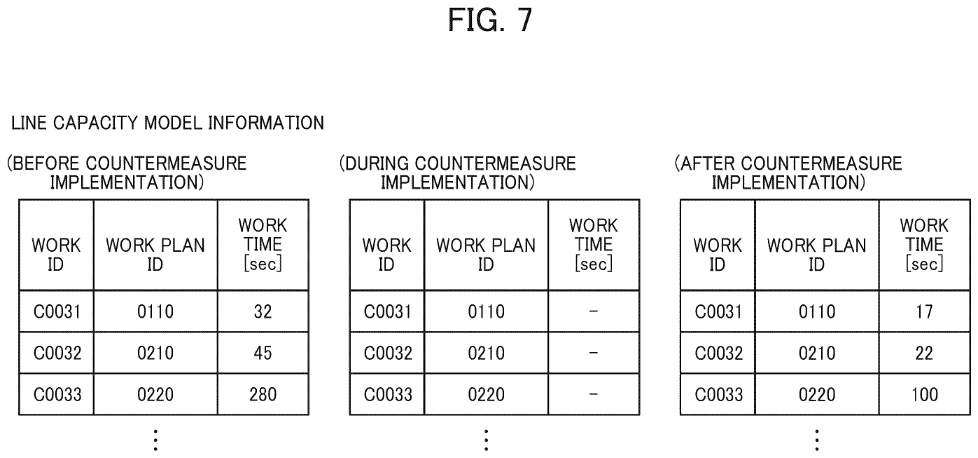

FIG. 7 is a diagram illustrating an example of the production line capacity model. As illustrated in FIG. 7, the production line capacity model includes the same items as the work plan information 124, and the phases of before, during, and after countermeasure implementation are different from each other in work time. For example, each work time in the production line capacity model before countermeasure implementation, that is, before unscheduled maintenance, has a value greater than the corresponding work time in the work plan information 124. This indicates that, due to a fault in a production resource, the production capacity is lower than in a normal state where there is no fault in the production resources. It should be noted that no work time is registered in the production line capacity model for the phase of during countermeasure implementation because the production line 300 is stopped during unscheduled maintenance. Further, the work time registered in the production line capacity model after countermeasure implementation is the same as the work time for the corresponding work in the work plan information 124 because the production capacity is already restored after countermeasure implementation, that is, after unscheduled maintenance.

It should be noted that, when multiple production lines 300 are related to a production resource that has outputted the abnormal value, that is, when multiple production lines 300 are identified in step S041, the capacity model creation section 113 performs the same process on each production line 300. That is to say, the production line capacity model is created for all combinations of countermeasure plans and production lines 300.

Next, the coordination planning section 114 generates maintenance configuration information that includes unscheduled maintenance work corresponding to each countermeasure plan and the number of workers, cost, and maintenance work time required for performing such maintenance work (step S043). Specifically, for each countermeasure plan, the coordination planning section 114 derives the number of workers required for performing the corresponding unscheduled maintenance work and the maintenance work time from countermeasure plan data. Further, the coordination planning section 114 derives the cost for unscheduled maintenance work (e.g., equipment cost and worker cost for parts replacement) from the cost information 132, and calculates the overall cost in accordance with the required number of workers and work time. Then, the coordination planning section 114 generates the maintenance configuration information that includes the above items of information.

Next, the coordination planning section 114 uses a predetermined production KPI as an objective function, and creates a plan by coordinating and simultaneously optimizing the unscheduled maintenance plan and the production plan change proposal (step S044). Specifically, the coordination planning section 114 uses the maintenance configuration information, the production plan information 125, and various information stored in the storage section 120 to maximize (optimize) the predetermined production KPI, and creates a plan by coordinating and simultaneously optimizing the unscheduled maintenance plan and the production plan change proposal, for example, through the use of a meta-heuristic method such as a MIP (Mixed Integer Programming) Solver or a GA (Genetic Algorithm).

It should be noted that the unscheduled maintenance plan is created as information in which the maintenance configuration information is associated with the execution timing (timing) of when the unscheduled maintenance work is to be performed. Further, the production plan change proposal is information indicating a production plan that has been changed in accordance with the execution timing of such unscheduled maintenance work.

As regards production KPIs such as the yield of manufactured products, the average availability of the production line 300, a production throughput, and a countermeasure cost, the coordination planning section 114 solves optimization problems related to the combination of maintenance timing and production plan change proposal in such a manner as to maximize predetermined production KPIs, and thus creates a plan by coordinating the unscheduled maintenance plan and the production plan change proposal. It should be noted that maximizing (optimizing) the product yield is to achieve a higher yield. Further, maximizing (optimizing) the average availability of the production line 300 is to provide higher average availability. Furthermore, maximizing (optimizing) the production throughput is to achieve a higher production throughput. Moreover, maximizing (optimizing) the countermeasure cost is to achieve a lower countermeasure cost.

It should be noted that the production KPI is not limited to those mentioned above and may be set as appropriate based on the perspective important to the user. Further, the production KPI need not necessarily include all of the product yield, the average availability of the production line 300, the production throughput, and the countermeasure cost, and may include any number of them (e.g., at least one of them, such as only the countermeasure cost).

When processing is performed up to step S043, a product production capacity in each of the phases of before, during, and after countermeasure implementation is calculated for each countermeasure plan and for each production line 300. Therefore, in consideration of the product production capacity, the coordination planning section 114 performs a production simulation while changing the execution timing of unscheduled maintenance corresponding to each countermeasure plan, and thus calculates the production KPI at each time of unscheduled maintenance. Consequently, it is possible to devise an unscheduled maintenance plan that maximizes a predetermined production KPI, and formulate a production plan for performing unscheduled maintenance work as the production plan change proposal.

Further, in a case where a production resource used for unscheduled maintenance is involved in multiple production lines 300, the coordination planning section 114 devises an unscheduled maintenance plan for each production line 300, and formulates a production plan corresponding to the unscheduled maintenance plan as the production plan change proposal.

It should be noted that the product yield is the ratio between the target production volume over a predetermined period (e.g., one month) in a case where no abnormality has occurred in the production resources and the actual production volume in a case where unscheduled maintenance work is performed in accordance with the countermeasure plan. The above-described product yield can be calculated by performing a production simulation based, for example, on the production plan information 125, processing plan information 123, work plan information 124, and input plan information 126 for a situation where no abnormality has occurred in the production resources, on the production line capacity model, and on the maintenance configuration information.

Further, the average availability, which is the average availability of the production line 300, is a value obtained by calculating the ratio between the actual operating time of the production line 300, including the downtime due to the implementation of unscheduled maintenance work corresponding to the countermeasure plan, and the availability (e.g., factory operating time) of the production line 300 during a predetermined period (e.g., one month) in a case where no abnormality has occurred in the production resources, and averaging the calculated ratio by dividing the calculated ratio by the number of days in the predetermined period. The above-described average availability of the production line 300 can be calculated by performing a production simulation based, for example, on the processing plan information 123, work plan information 124, production plan information 125, and input plan information 126 for a situation where no abnormality has occurred in the production resources, on the line configuration information 122, on the production line capacity model, and on the maintenance configuration information.

Further, the production throughput is the average production volume per predetermined time (e.g., per minute) during a predetermined period (e.g., one month) that is determined by considering a decrease in the product production volume in a case where unscheduled maintenance work corresponding to the countermeasure plan is performed. The above-described production throughput can be calculated by performing a production simulation based, for example, on the processing plan information 123, work plan information 124, production plan information 125, and input plan information 126 for a situation where no abnormality has occurred in the production resources, on the production line capacity model, and on the maintenance configuration information.

Further, the countermeasure cost is the cost of unscheduled maintenance work corresponding to the countermeasure plan, such as a plan for parts replacement and equipment adjustment. It should be noted that countermeasure cost includes, for example, a labor cost of workers performing unscheduled maintenance work, and an overtime pay for workers working overtime to compensate for a decrease in the production volume due to countermeasure implementation and maintain the target production volume indicated by the input plan. Furthermore, the countermeasure cost also includes a penalty cost due to delivery delays caused by the failure to achieve the target production volume indicated by the input plan due to the timing of unscheduled maintenance work. The above-described countermeasure cost can be calculated by performing a production simulation based, for example, on the processing plan information 123, work plan information 124, production plan information 125, and input plan information 126 for a situation where no abnormality has occurred in the production resources, on the production line capacity model, on the maintenance configuration information, and on the cost information 132.

It should be noted that each calculated production KPI is stored in the storage section 120 in association with the unscheduled maintenance plan and the production plan change proposal.

Further, after performing the processing of step S044 for each countermeasure plan, the coordination planning section 114 moves the process to step S050 (FIG. 5).

Next, the countermeasure evaluation section 115 outputs a countermeasure confirmation screen for the countermeasure plan that maximizes a predetermined KPI (step S050). Specifically, the countermeasure evaluation section 115 generates such a countermeasure confirmation screen through the display section 150, and outputs the generated countermeasure confirmation screen to the presentation device.

More specifically, the countermeasure evaluation section 115 acquires, from the storage section 120, an unscheduled maintenance plan corresponding to a countermeasure plan associated with a predetermined countermeasure ID and a production KPI corresponding to the countermeasure plan. Further, the countermeasure evaluation section 115 outputs the countermeasure confirmation screen including the production KPI to the presentation device through the display section 150.

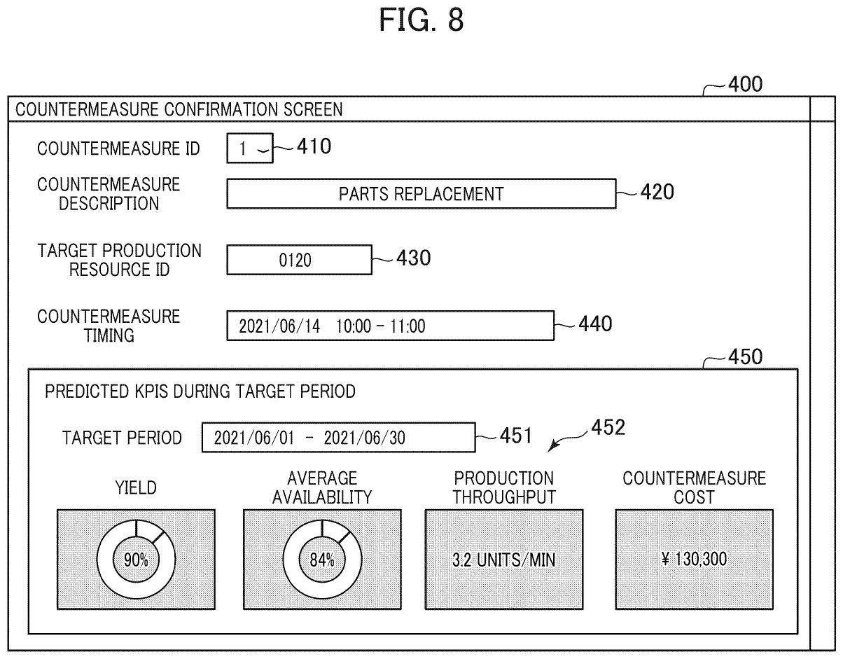

FIG. 8 is a diagram illustrating an example of the countermeasure confirmation screen. The countermeasure confirmation screen 400 illustrated as the example is a countermeasure confirmation screen for a countermeasure plan for a situation where one production line 300 involves a faulty production resource.

As illustrated in FIG. 8, the countermeasure confirmation screen 400 includes a countermeasure ID display area 410, a countermeasure description display area 420, a target production resource ID display area 430, a countermeasure timing display area 440, and a target period KPI prediction display area 450. The countermeasure ID display area 410 is an area for displaying an ID that identifies a countermeasure plan corresponding to a formulated unscheduled maintenance plan. The countermeasure description display area 420 is an area for displaying the description of a countermeasure indicated by the countermeasure plan corresponding to the formulated unscheduled maintenance plan. The target production resource ID display area 430 is an area for displaying an ID that identifies a target production resource on which unscheduled maintenance is to be performed. The countermeasure timing display area 440 is an area for displaying the date and time when unscheduled maintenance work is to be performed. The target period KPI prediction display area 450 is an area for displaying each production KPI in a case where the countermeasure plan corresponding to the formulated unscheduled maintenance plan is implemented.

The target period KPI prediction display area 450 includes a target period display area 451 for displaying the target period for production KPI, and an area 452 for displaying the value of each production KPI. The displayed production KPIs, namely, the yield, the average availability, the production throughput, and the countermeasure cost, each indicate the production KPI in a case where an unscheduled maintenance plan corresponding to the countermeasure plan identified by a selected countermeasure ID is implemented.

It should be noted that the countermeasure ID to be displayed in the countermeasure ID display area 410 is user-selectable through an input device 610. Additionally, the countermeasure evaluation section 115 acquires, from the storage section 120, an unscheduled maintenance plan corresponding to the countermeasure ID received from the user through the input section 140, and causes the display section 150 to display the description of a countermeasure corresponding to the unscheduled maintenance plan, the target production resource ID, the countermeasure timing, and the production KPIs in their respective display areas.

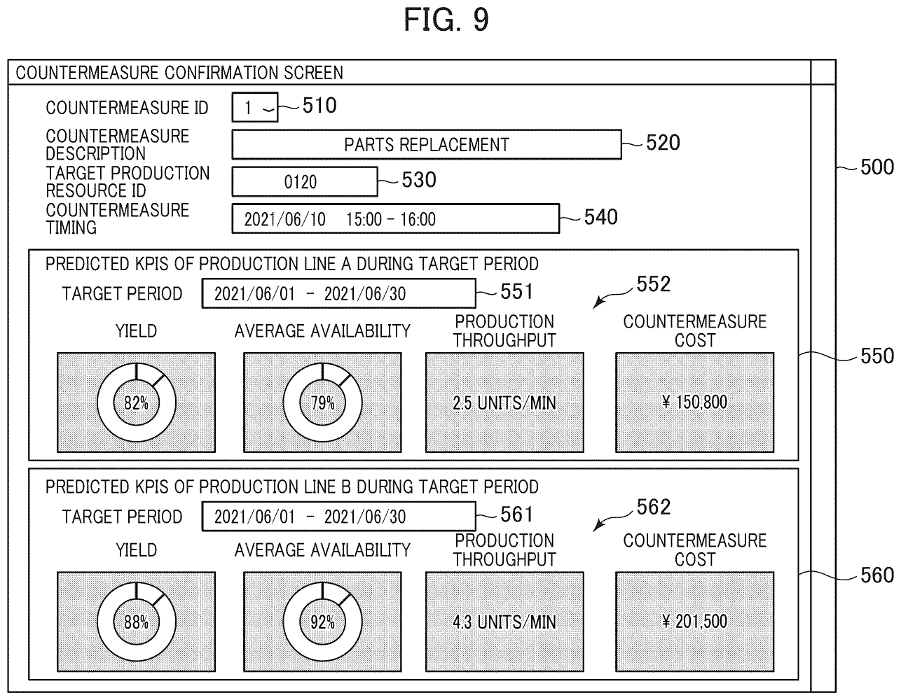

FIG. 9 is a diagram illustrating another example of the countermeasure confirmation screen. The countermeasure confirmation screen 500 illustrated as the example is a countermeasure confirmation screen for a countermeasure plan for a situation where two production lines 300 involve faulty production resources. As illustrated in FIG. 9, in a case where two production lines 300 are targeted, the countermeasure confirmation screen 500 is provided with target period KPI prediction display areas 550, 560 for the production lines 300. The target period KPI prediction display areas 550, 560 display the production KPIs of the respective production lines 300. That is to say, the countermeasure confirmation screen 500 displays a number of target period KPI prediction display areas as needed for the production lines 300 that involve faulty production resources. Target period display areas 551, 561 and areas 552, 562 for displaying the values of production KPIs are similar to those displayed in the countermeasure confirmation screen 400, and will not be redundantly described in detail.

Further, the countermeasure evaluation section 115 may evaluate the production KPIs corresponding to the respective countermeasure plans, and output the countermeasure confirmation screen regarding a countermeasure plan that maximizes (optimizes) a predetermined production KPI (e.g., countermeasure cost) important to the user.

Specifically, the countermeasure evaluation section 115 causes the display section 150 to display screen information for accepting an input of the predetermined production KPI important to the user. Furthermore, upon receiving an input of information indicating such a production KPI from the user through the input section 140, the countermeasure evaluation section 115 evaluates the production KPIs corresponding to the respective countermeasure plans. Moreover, the countermeasure evaluation section 115 specifies a countermeasure plan that maximizes (optimizes) the inputted production KPI, and causes the display section 150 to generate and display screen information for the countermeasure confirmation screen including the countermeasure description display area and target period KPI prediction display area corresponding to the specified countermeasure plan.

As a result, the user can easily confirm the contents of the countermeasure plan formulated to maximize the important production KPI, and confirm other production KPIs in the countermeasure plan.

The control program generation section 116 generates the robot program 128 and the ladder program 129 in accordance with the production plan change proposal corresponding to the countermeasure plan identified by the countermeasure ID selected by the user, and transmits the generated control program and control information to the control system 200 through the communication section 160. This makes it possible to control each production resource in the production line 300 in accordance with the production plan change proposal that has been made in consideration of the unscheduled maintenance plan.

The production management device according to the present embodiment makes it possible to formulate multiple countermeasures that can be quantitatively evaluated from the perspective of multiple evaluation indicators. Particularly, by predicting the production capacity of a production line that varies from one situation to another in time series, namely, the phases of before, during, and after countermeasure implementation, the production management device is able to calculate the evaluation indicators through the use of the predicted value of such a production capacity with higher accuracy.

Further, the production management device coordinately formulates the unscheduled maintenance plan and the production plan change proposal in consideration of the production capacity of the production line. Consequently, the production management device is able to devise the unscheduled maintenance plan in such a manner as to maximize predetermined evaluation indicators, and formulate the production plan change proposal.

A hardware configuration of the production management device 100 will now be described.

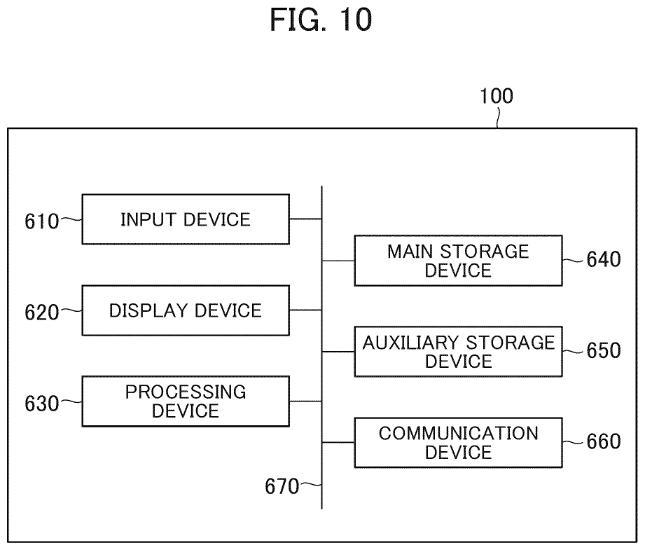

FIG. 10 is a diagram illustrating an example of the hardware configuration of the production management device 100. As illustrated in FIG. 10, the production management device 100 includes an input device 610, a display device 620, a processing device 630, a main storage device 640, an auxiliary storage device 650, a communication device 660, and a bus 670 that electrically interconnects the above devices.

The input device 610 is, for example, a touchscreen, a keyboard, a mouse, or other input device. The display device 620 is, for example, a liquid-crystal display, an organic display, or other display device.

The processing device 630 is, for example, a CPU (Central Processing Unit), a GPU (Graphics Processing Unit), or other arithmetic device. The main storage device 640 is a memory device such as a RAM (Random Access Memory) or a ROM (Read Only Memory).

The auxiliary storage device 650 is a non-volatile storage device capable of storing digital information, such as a hard disk (hard disk drive), an SSD (Solid State Drive), or a flash memory.

The communication device 660 is a communication device for providing wired communication or a wireless communication device for providing wireless communication through an antenna.

An example of the hardware configuration of the production management device 100 has been described above.

The processing section 110 of the above-described production management device 100 is implemented by a program that causes the processing device 630 to perform various arithmetic processes. The program is stored in the main storage device 640 or the auxiliary storage device 650. When the program is to be executed, it is loaded onto the main storage device 640 and then executed by the processing device 630.

The input section 140 is implemented by the input device 610. The display section 150 is implemented by the display device 620. The storage section 120 is implemented by the main storage device 640, the auxiliary storage device 650, or a combination thereof. The communication section 160 is implemented by the communication device 660.

Further, for example, the above-described component elements, functions, processing sections, and processing means of the production management device 100 may be partly or wholly implemented by hardware, that is, for example, by designing them with integrated circuits. Furthermore, for example, the above-described components and functions may be implemented by software by allowing a processor to interpret and execute programs for implementing individual functions. Information regarding, for example, programs, tables, and files for implementing the individual functions may be stored in a storage device, such as a memory, a hard disk, or an SSD, or in a recording medium, such as an IC card, an SD card, or a DVD.

The present invention is not limited to the foregoing embodiment and modifications, and is intended to include various other modifications within the scope of the same technical idea. For example, the foregoing embodiment has been described in detail in order to facilitate the understanding of the present invention. The present invention need not necessarily include all of the above-described component elements. In addition, part of the configuration of one example can be replaced with the configurations of other examples, and in addition, the configuration of the one example can also be added with the configurations of other examples. Further, some component elements of individual embodiments may be added to, deleted from, or replaced with other component elements.

Furthermore, control lines and information lines considered necessary for explanation are used in the above description, and all the control lines and information lines relevant to products are not necessarily described. Actually, almost all component elements may be considered interconnected.

### List of Reference Signs

1000: Production management system
100: Production management device
110: Processing section
111: Abnormality detection section
112: Countermeasure planning section
113: Capacity model creation section
114: Coordination planning section
115: Countermeasure evaluation section
116: Control program generation section
120: Storage section
121: Measurement information
122: Line configuration information
123: Processing plan information
124: Work plan information
125: Production plan information
126: Input plan information
127: Maintenance plan information
128: Robot program
129: Ladder program
130: Countermeasure plan information
131: Line capacity information
132: Cost information
140: Input section
150: Display section
160: Communication section
610: Input device
620: Display device
630: Processing device
640: Main storage device
650: Auxiliary storage device
660: Communication device
670: Bus
200: Control system
300: Production line
N: Network

1. A production management device comprising:
a countermeasure planning section that formulates a countermeasure plan for production resources of factory equipment in which an abnormality is detected;
a storage section that stores line capacity information and plan information, the line capacity information being associated with the countermeasure plan and the production resources and including registered parameters indicating the production capacity of a production line before and after countermeasure implementation, the plan information indicating the production capacity of the production line that involves the production resources in a normal state; and
a capacity model creation section that creates a capacity model predicting the production capacity of the production line before and after countermeasure implementation based on the countermeasure plan through the use of the formulated countermeasure plan, the line capacity information, and the plan information.

2. The production management device according to claim 1,
wherein the capacity model creation section
creates a capacity model that predicts the production capacity of the production line in time series before, during, and after countermeasure implementation based on the countermeasure plan.

3. The production management device according to claim 2, further comprising:
a coordination planning section that generates maintenance configuration information including the description of maintenance work corresponding to the countermeasure plan, the number of workers required, work time, and cost.

4. The production management device according to claim 3,
wherein the coordination planning section
uses the capacity model and the maintenance configuration information, and
formulates a maintenance plan, including maintenance timing for performing the maintenance work and the maintenance configuration information, and a production plan change proposal for a product to be changed by the maintenance work, in such a manner as to maximize a predetermined production KPI (Key Performance Indicator) in accordance with the combination of the maintenance timing and the production plan change proposal.

5. The production management device according to claim 4,
wherein the production KPI includes at least one of a product yield in a case where the maintenance plan corresponding to the countermeasure plan is implemented, an average availability of the production line, a production throughput, or a countermeasure cost.

6. The production management device according to claim 5, further comprising:
a countermeasure evaluation section that evaluates the production KPIs corresponding to the countermeasure plans, and identifies the countermeasure plan that maximizes a predetermined production KPI.

7. The production management device according to claim 5, further comprising:
a display section that displays the production KPI and the description of the countermeasure plan corresponding to the production KPI.

8. The production management device according to claim 6,
wherein the countermeasure planning section formulates a plurality of countermeasures for the production resource; and
the countermeasure evaluation section evaluates the production KPI, and identifies the countermeasure plan that maximizes the countermeasure cost.

9. The production management device according to claim 4, further comprising:
a control program generation section that generates a control program for controlling each device of factory equipment involved in the production line in accordance with the production plan change proposal.

10. A production management system including a production management device for managing the production of products and a control system for controlling production resources in a production line, the production management system comprising:
a countermeasure planning section that formulates a countermeasure plan for production resources of factory equipment in which an abnormality is detected;
a storage section that stores line capacity information and plan information, the line capacity information being associated with the countermeasure plan and the production resources and including registered parameters indicating the production capacity of the production line before and after countermeasure implementation, the plan information indicating the production capacity of the production line that involves the production resources in a normal state;
a capacity model creation section that creates a capacity model predicting the production capacity of the production line before and after countermeasure implementation based on the countermeasure plan through the use of the formulated countermeasure plan, the line capacity information, and the plan information;
a coordination planning section that generates maintenance configuration information including the description of maintenance work corresponding to the countermeasure plan, the number of workers required, work time, and cost, uses the capacity model and the maintenance configuration information, and coordinately formulates a maintenance plan, including maintenance timing for performing the maintenance work and the maintenance configuration information, and a production plan change proposal for a product to be changed by the maintenance work, in such a manner as to maximize a predetermined production KPI (Key Performance Indicator) in accordance with the combination of the maintenance timing and the production plan change proposal; and
a control program generation section that generates a control program for controlling each device of factory equipment involved in the production line in accordance with the production plan change proposal, and transmits the generated control program to the control system.

11. A production management method used by a production management device, the production management method comprising:
a countermeasure planning step of causing the production management device to formulate a countermeasure plan for production resources of factory equipment in which an abnormality is detected;
a storage step of causing the production management device to stores line capacity information and plan information, the line capacity information being associated with the countermeasure plan and the production resources and including registered parameters indicating the production capacity of the production line before and after countermeasure implementation, the plan information indicating the production capacity of the production line that involves the production resources in a normal state; and
a capacity model creation step of causing the production management device to create a capacity model predicting the production capacity of the production line before and after countermeasure implementation based on the countermeasure plan through the use of the formulated countermeasure plan, the line capacity information, and the plan information.
